(19) United States
(12) Patent Application Publication
(10) Pub. No.: US 2024/0119167 A1
(43) Pub. Date: Apr. 11, 2024

(54) DATA MANAGEMENT SYSTEM, DATA MANAGEMENT SERVER, DATA MANAGEMENT METHOD, DATA MANAGEMENT PROGRAM, AND RECORDING MEDIUM

(71) Applicant: FANUC CORPORATION, Minamitsuru-gun, Yamanashi (JP)

(72) Inventor: Hiroki HOKAZONO, Yamanashi (JP)

(21) Appl. No.: 18/276,968

(22) PCT Filed: Mar. 7, 2022
(86) PCT No.: PCT/JP2022/009663

§ 371 Date: Aug. 11, 2023

(30) Foreign Application Priority Data
Mar. 12, 2021 (JP) 2021-040740

(51) Int. Cl. G06F 21/62

(52) U.S. Cl. CPC G06F 21/6218

(57) ABSTRACT

When a data provider provides data to the outside, an application not intended by the data provider to use the data is prevented from doing so. A reception-side server comprises a data usage condition information management unit which: when available application information, in which an application name for allowing access to data provided from outside is set, is added to the data, registers data usage condition information; and when an access request for the data is received from any application, allows access to the data only to applications that are authorized to access the data on the basis of the data usage condition information.

### TECHNICAL FIELD

The present invention relates to a data management system, a data management server, a data management method, a data management program, and a recording medium.

### BACKGROUND ART

In the field of manufacturing equipment, in recent years, server application software (hereinafter, simply referred to as “applications” or “apps”) such as “visualization”, “quality improvement”, “maintenance” and “developer tool software/converter” having various functions and purposes for manufacturing sites has been developed in various companies.

For example, when a developer such as a system integrator develops an application for a manufacturing site based on the processing data accompanying the operation of edge devices such as machine tools, industrial device, and industrial robots in the manufacturing site, the developer needs to obtain the processing data accompanying the operation of the edge devices necessary for the application, transmit the processing data to a database in the developer's development environment, and perform the application development work (for example, refer to Patent Document 1).

More specifically, the processing data of the edge device includes, for example, data indicating an action state of the edge device, data indicating a production state, data indicating a quality state of a product, data indicating an event (history) such as an operation state, and the like. These pieces of processing data are data-modeled (i.e., standardized) in advance, and by storing these standardized processing data (hereinafter also referred to as “virtual device data”) in a predetermined database corresponding to the standardized data model, the application can access the processing data via a predetermined API (hereinafter also referred to as “access API”). The processing data of the edge device provided from the manufacturing site is stored in a form corresponding to a data model standardized in a database in the development environment.

An example of a form for providing the processing data accompanying the operation of the edge device, which is provided from a providing-side server to a receiving-side server, is shown. Here, the providing-side server is installed in the manufacturing site environment, and the receiving-side server is installed in the development environment.

The processing data stored in the database included in the providing-side server and accompanying the operation of the edge device is outputted as virtual device data by a database operation tool, encrypted, and exported to the outside. The encrypted virtual device data is provided to a receiving-side server, which imports and decrypts the encrypted virtual device data, and then stores the encrypted virtual device data in a database included in the receiving-side server by the database operation tool.

With such a configuration, the developer can access the processing data via the access API to perform the application development work.
Patent Document 1: Japanese Unexamined Patent Application, Publication No. 2020-021214

### DISCLOSURE OF THE INVENTION

### Problems to be Solved by the Invention

Here, even if the provider of the processing data accompanying the operation of the edge device encrypts the processing data and provides the encrypted processing data to the developer of the application, the processing data is stored in the database in a decrypted state when the processing data is stored in the database in the development environment. This makes it possible for other applications running in the same development environment to utilize the processed data via the access API, which may cause potential security risks for the data provider. Then, for example, by analyzing the machine information, it is possible to grasp how much manufacturing capability each machine has. Furthermore, it is possible to grasp how many products are manufactured by the factory by recognizing the manufacturing capability of each machine. Moreover, the sales of the company operating the factory can be grasped by recognizing the manufacturing capability of the factory.

For this reason, a function is required in which, when data is provided to the outside, a data provider designates in advance an application or a name of the application which can use the data so that another application which is not designated cannot access the data.

It is an object for the present invention to provide a data management system, a data management server, a data management method, a data management program, and a recording medium capable of securely preventing an application which is not intended by a data provider from using the data without accessing the data by the data provider designating in advance an application which can use the data, when data is provided to the outside, so that another application which is not designated cannot access the data.

### Means for Solving the Problems

(1) An aspect of a data management server according to the present invention is directed to a data management server including: a control unit; a database; a data use condition information management unit configured to record and manage data use condition information in which information relating to a data file stored in the database and an application or a name of the application permitted to access the data file are associated with each other, and when receiving an access request for any data stored in the database from any application running, permits only an application permitted to access the data based on the data use condition information to access the data; and a data transmission unit configured to, when available application information in which an application or a name of the application that is permitted to access the data file is set is added to the data file provided from outside of the data management server, register data use condition information in which information relating to the data file is associated with the application or the name of the application that is permitted to access the data file in the data use condition information management unit, and transmit the data file to the database.

(2) An aspect of a data management method according to the present invention is directed to a data management method for storing a data file provided from outside in an internal database and allowing an internal application to use the data file, the method executed by a computer including a control unit and a database, and including the steps of: recording and managing data use condition information in which information relating to a data file stored in the database and an application or a name of the application permitted to access the data file are associated with each other and, when receiving an access request for any data stored in the database from any application running, permitting only an application permitted to access the data based on the data use condition information to access the data; and when available application information in which an application or a name of the application that is permitted to access the data file is set is added to the data file provided from outside of the data management server, registering data use condition information in which information relating to the data file is associated with the application or the name of the application that is permitted to access the data file, and transmitting the data file to the database.

(3) An aspect of a data program according to the present invention is directed to a data management program for storing a data file provided from outside in an internal database and allowing an internal application to use the data file, the program executed by a computer including a control unit and a database, and including the steps of: recording and managing data use condition information in which information relating to a data file stored in the database and an application or a name of the application permitted to access the data file are associated with each other and, when receiving an access request for any data stored in the database from any application running, permitting only an application permitted to access the data based on the data use condition information to access the data; and when available application information in which an application or a name of the application that is permitted to access the data file is set is added to the data file provided from outside of the data management server, registering data use condition information in which information relating to the data file is associated with the application or the name of the application that is permitted to access the data file, and transmitting the data file to the database.

(4) An aspect of a data management system according to the present invention is directed to a data management system including: a receiving-side server serving as a data management server according (1); and a providing-side server that creates a data file provided from outside to the receiving-side server, the providing-side server including a control unit, and a database, the control unit including a data acquisition unit configured to acquire a data file stored in the database, a data use condition creation unit configured to add to the data file available application information in which an application or a name of the application executed by the receiving-side server that is permitted to access the data file is set, and a data output unit configured to output the data file to which the available application information is added by the data use condition creating unit to outside as a provision data file to be provided to the receiving-side server.

### Effects of the Invention

According to the present invention, it is possible to provide a data management system, a data management server, a data management method, a data management program, and a recording medium capable of securely preventing an application which is not intended by a data provider from using the data without accessing the data by the data provider which designates, when data is provided to the outside, in advance an application which can use the data so that another application which is not designated cannot access the data.

### BRIEF DESCRIPTION OF THE DRAWINGS

FIG. 1 is a schematic diagram showing a basic configuration of a data management system according to one embodiment of the present invention;

FIG. 2 is a functional block diagram of a providing-side server according to the present embodiment;

FIG. 3 is a schematic diagram of a providing-side application program executed by a providing-side server according to the present embodiment;

FIG. 4 is a functional block diagram of a receiving-side server as a data management server according to the present embodiment;

FIG. 5 is a schematic diagram of a receiving-side application program executed by the receiving-side server according to the present embodiment;

FIG. 6 is a diagram showing an example of data use condition information according to the present embodiment;

FIG. 7 is a flowchart showing processing for creating data to be provided to the outside from the database of the providing-side server according to the present embodiment;

FIG. 8 is a flowchart showing processing until the receiving-side server receives a data file from the outside and stores the data file in the database;

FIG. 9 is a flowchart showing processing in which an application accesses a database and acquires data in the receiving-side server according to the present embodiment; and

FIG. 10 is a schematic diagram showing an example of a mode in which provision data from the providing-side server via the cloud is provided to the receiving-side server according to the present embodiment.

### PREFERRED MODE FOR CARRYING OUT THE INVENTION

An example of the configuration of the data management system 1000 according to the present embodiment will be described. Here, as data, processing data accompanying the operation of edge devices such as machine tools, industrial devices, and industrial robots in the manufacturing site is exemplified. Furthermore, as an example of an external server that creates and provides data, a server (also referred to as a “providing-side server”) that accesses processing data of manufacturing equipment (edge device) including a CNC machine tool, industrial device, industrial robot, and the like installed in a manufacturing site such as a factory, and performs predetermined information processing relating to the application is exemplified. Furthermore, as a server (also referred to as a “receiving-side server”) of the present invention, for example, a server installed in a development environment, in which a developer develops an application based on data provided from the providing-side server, is exemplified. However, the data, the server, and the like of the present invention are not limited thereto. The present invention can be applied to any data and any server.

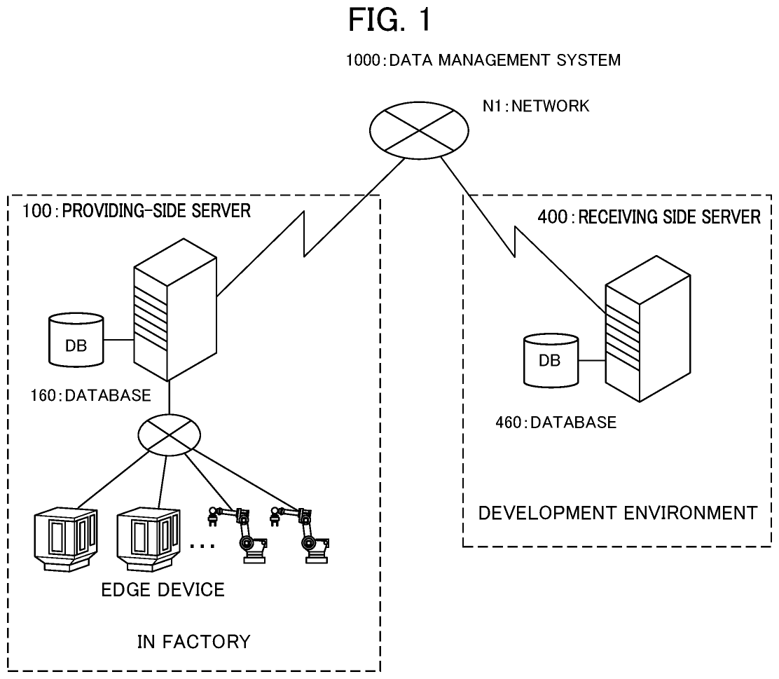

FIG. 1 is a schematic diagram showing the basic configuration of the data management system 1000 according to the present embodiment. As shown in FIG. 1, the data management system 1000 includes a providing-side server 100 and a receiving-side server 400 serving as a data management server. It should be noted that the providing-side server 100 and the receiving-side server 400 may be connected via the network N1. Examples of the network include the Internet, a VPN (Virtual Private Network), and a public telephone network. There are no particular restrictions on a specific communication method in the network, and whether the network is wired or wireless.

In the present embodiment, the providing-side server 100 is, for example, a server that executes an application to access processing data of manufacturing equipment (edge device) including a CNC machine tool, industrial device, industrial robot, and the like installed in a manufacturing site such as a factory to perform predetermined information processing relating to the application. Here, the processing data indicates virtual device data such as data indicating an action state of the edge device, data indicating a production state, data indicating a quality state of a product, and data indicating an operation state. The data provider extracts, for example, processing data (virtual device data) of the edge device from the database 160 of the providing-side server 100, and provides the extracted processing data to the developer. With such a configuration, the developer can store the processing data (virtual device data) in the database 460 (e.g., debugging database) of the receiving-side server 400 as a development environment, and can perform the application development work using the processing data (virtual device data).

The receiving-side server 400 can execute any application. However, the virtual device data provided from the providing-side server 100 and stored in the database 460 of the receiving-side server 400 is configured such that only an application permitted to be accessed by a provider of the data can access the data.

Next, functions of each device of the data management system 1000 will be described.

### <Providing-Side Server 100>

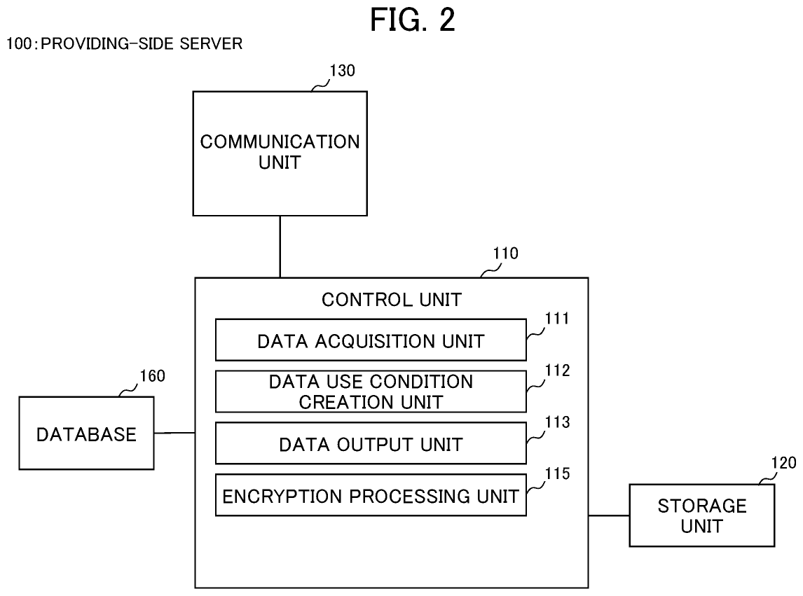

FIG. 2 is a functional block diagram showing functions of the providing-side server 100. As shown in FIG. 2, the providing-side server 100 includes a control unit 110, a storage unit 120, a communication unit 130, and a database 160. The database is built in an internal or external storage device managed by the providing-side server 100.

Before describing the control unit 110, the storage unit 120, the communication unit 130, and the database 160 will be briefly described.

The storage unit 120 stores programs executed by the control unit 110, and has a storage area (referred to as a “data storage unit”) for temporarily storing data acquired from the database 160 by the data acquisition unit 111, as will be described later.

The communication unit 130 is a communication control device that transmits and receives data to and from an external device (for example, an edge device, a client terminal, a receiving-side server 400, and the like) via a network.

In the present embodiment, as described above, the database 160 stores, for example, data (virtual device data) generated based on a standardized data model of processing data of the edge devices.

Specifically, in the database 160 exemplified in the present embodiment, a data structure for storing virtual device data generated based on a standardized data model is prepared in advance. One element of such a data structure is referred to as an instance, and an identifier thereof is referred to as an instance ID. Each piece of data stored in the instance is also referred to as a moment. Specifically, data in one time stamp is referred to as a moment.

Furthermore, the database 160 illustrated in the present embodiment is configured to be stored in an instance identified by an instance ID by designating the instance ID and transmitting the data (specifically, POST transmission) in order to store one virtual device data in the instance. Thus, by transmitting data using the instance ID as a transmission destination, the data is recorded in the instance. The database 160 illustrated in this embodiment may include the database operation tool and the access API described above. However, the present invention is not limited to virtual device data and a database system that stores virtual device data. The present invention can be applied to any data and any database system that stores the data. Specifically, since the terms “instance”, “moment”, “data transmission unit” and “transmit data to database” in the database 160 exemplified in the present embodiment correspond to “data files such as tables”, “one record data”, “data registration unit” and “storing data in database” in a normal database, respectively, the present invention can be read as described above. Therefore, the present invention can be applied to any data and any database storing the data.

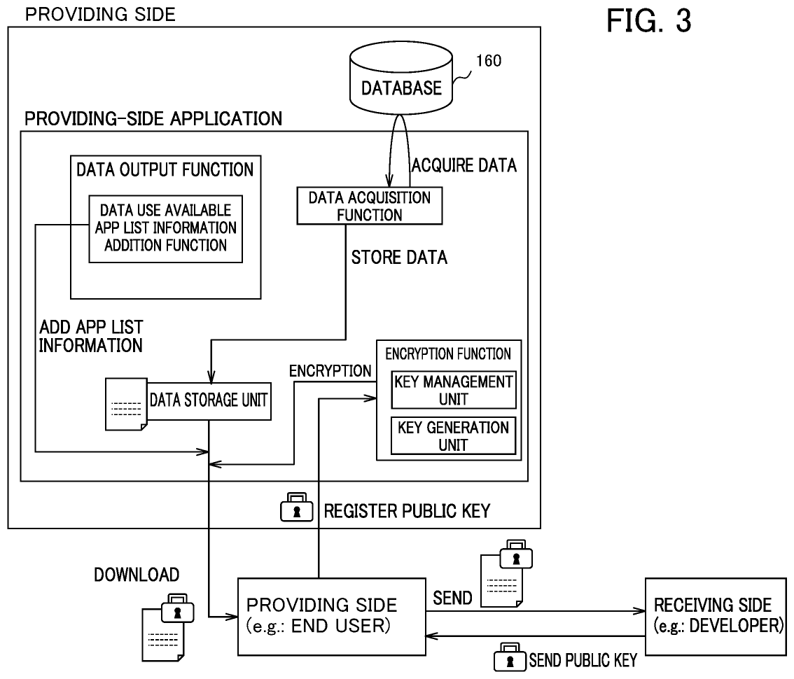

The control unit 110 is, for example, a CPU, and controls the providing-side server 100 by executing various programs stored in the storage unit 120. FIG. 3 is a schematic diagram of a providing-side application program (also referred to as a “provision data creation program”) executed by the providing-side server 100. Hereinafter, the “application” may also be referred to as an “app”.

For example, the control unit 110 executes a program for obtaining virtual device data to be provided to the receiving-side server 400 from the database 160 (hereinafter, also referred to as “data obtaining processing”), and temporarily stores the obtained virtual device data in the storage unit 120. Among the applications executed by the receiving-side server 400, a program is executed for adding list information of applications that enable the provision data (that is, permit access to the provision data) (“data available application list information addition function” or “data available application list information addition function”) and outputting data (hereinafter, also referred to as “data output processing”) to be outputted to the outside (hereinafter, also referred to as “export”). When the provision data is outputted to the outside, a program for encrypting a provision data file (hereinafter, also referred to as “encryption processing”) may be executed using key data of a public key system or a common key of a common key system in order to ensure the security of the data.

It should be noted that the program (in particular, a program for data acquisition and a program for data output) for the provision data creation processing may be a program included in management software (hereinafter also referred to as “database operation tool”) prepared in the database 160.

As shown in FIG. 2, by executing the provision data creation program, the control unit 110 includes a data acquisition unit 111, a data use condition creation unit 112, a data output unit 113, and an encryption processing unit 115 as functional configurations.

First, the data acquisition unit 111 will be described.

The data acquisition unit 111 acquires provision data from the database 160 in response to a data acquisition instruction inputted from a user (for example, a data provider) via, for example, a terminal (not shown) communicably connected to the providing-side server 100. The acquired data may be stored in the data storage unit of the storage unit 120. Here, the instruction information included in the data acquisition instruction may include a data file name (for example, an instance ID) and a target range (for example, the identification information of the first data and the identification information of the last data as a provision target range) of data to be provided among data included in the data file. Furthermore, the number of data to be acquired may be designated. When the provision target range is not designated, the data acquisition unit 111 may acquire all the data included in the data file, and may create the first identification information and the last identification information of the data included in the data file as defaults. When the provision data is virtual device data, a time stamp assigned to each data may be applied as identification information designating the target range.

The data acquisition instruction may include the data available application list information designating an application or an application name that is permitted to access to the data among the applications executed at the data providing destination (i.e., the receiving-side server 400). Thus, a user (e.g., a data provider) can input information necessary for providing data at the same time, so that input efficiency can be improved. In this case, the data acquisition unit 111 may provide the data available application list information to a data use condition creation unit 112, which will be described later.

The data available application list information may include one or more application names. It should be noted that, when access of the data to any application executed in the receiving-side server 400 is permitted, the data available application list information may be null (hereinafter also referred to as “empty”).

Furthermore, among the data provided to the receiving-side server 400, a target range of the data may be divided into several partial ranges, and a data available application or its name may be designated for each partial range.

Next, the data use condition creation unit 112 will be described. The data use condition creation unit 112 adds the available application information in which the application or its name executed by the receiving-side server 400 and permitted to access to the data in the target range is set, the available application information corresponding to, for example, the provision target range of the data file which is extracted from the database by the data acquisition unit 111 and stored in the data storage unit of the storage unit 120. The data use condition creation unit 112 may be included in a data output unit 113 described later. The user can input the data to the data use condition creating unit 112 via a client terminal or the like (not shown), corresponding to the provision target range of the data file stored in the data storage unit (not shown).

When the available application list information is not designated, the data use condition creation unit 112 creates the available application information as empty (null). With such a configuration, available application information including null information is added to data provided from the providing-side server 100 to the outside.

Finally, the data output unit 113 will be described. The data output unit 113 outputs the data file to which the available application information is added by the data use condition creation unit 112 to the outside as a data file (hereinafter, also referred to as a “provision data file”) to be provided to the receiving-side server 400.

The data output unit 113 may encrypt the provision data file using key data of a public key system or a common key of a common key system in order to ensure security of data when outputting the data to the outside.

Specifically, the control unit 110 may include an encryption processing unit 115. In this case, for example, the public key of the receiving side is notified in advance to the providing side, so that the encryption processing unit 115 may encrypt by applying the public key. Furthermore, the encryption processing unit 115 may generate a common key, encrypt the generated common key by applying a public key to the generated common key, and generate an encrypted common key and provision data encrypted by applying the common key.

The provision data file outputted to the outside by the data output unit 113 may be transmitted to the receiving-side server 400 via the communication unit 130. Alternatively, the provision data file may be stored in a storage medium, and may be mailed or handed over. As described later, the providing-side server 100 may upload the provision data file to the cloud, and the receiving-side server 400 may download the provision data file from the cloud.

The functions of the providing-side server 100 have been described above. Next, functions of the receiving-side server 400 will be described.

### <Receiving-Side Server>

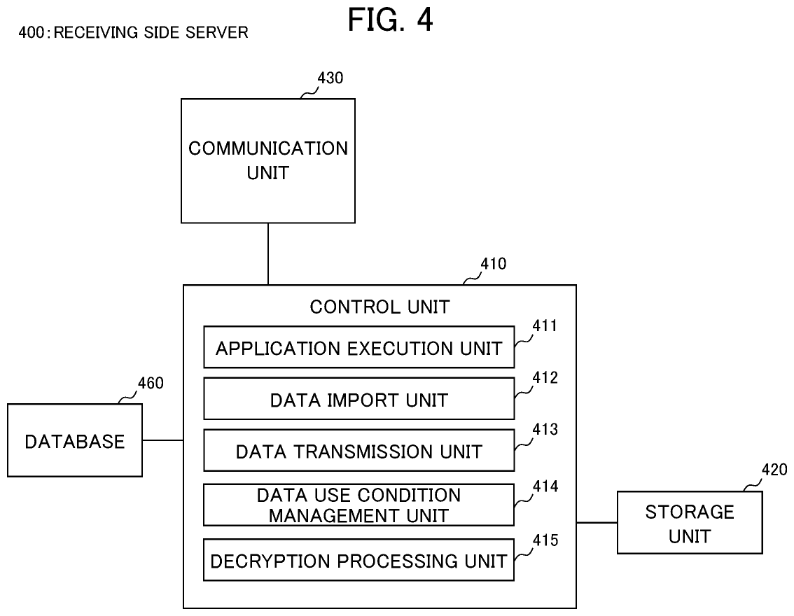

FIG. 4 is a functional block diagram showing functions of the receiving-side server 400. As shown in FIG. 4, the receiving-side server 400 includes a control unit 410, a storage unit 420, a communication unit 430, and a database 460. The database 460 is built in an internal or external storage device managed by the receiving-side server 400. The storage unit 420 and the communication unit 430 are equivalent to those of the providing-side server 100, and a description thereof will be omitted. The receiving-side server 400 may be implemented as a virtual server on the cloud known to those skilled in the art.

The database 460 may have the same function as the database 160 of the providing-side server 100. Therefore, as described above, the database operation tool and the access API related to the database 460 may be prepared in advance in the receiving-side server. Furthermore, in order to store the virtual device data in a predetermined instance of the database 460, the instance ID is designated and the data is transmitted to be stored in the instance that identifies the instance ID. Thus, by transmitting data using the instance ID as a transmission destination, the data is recorded in the instance.

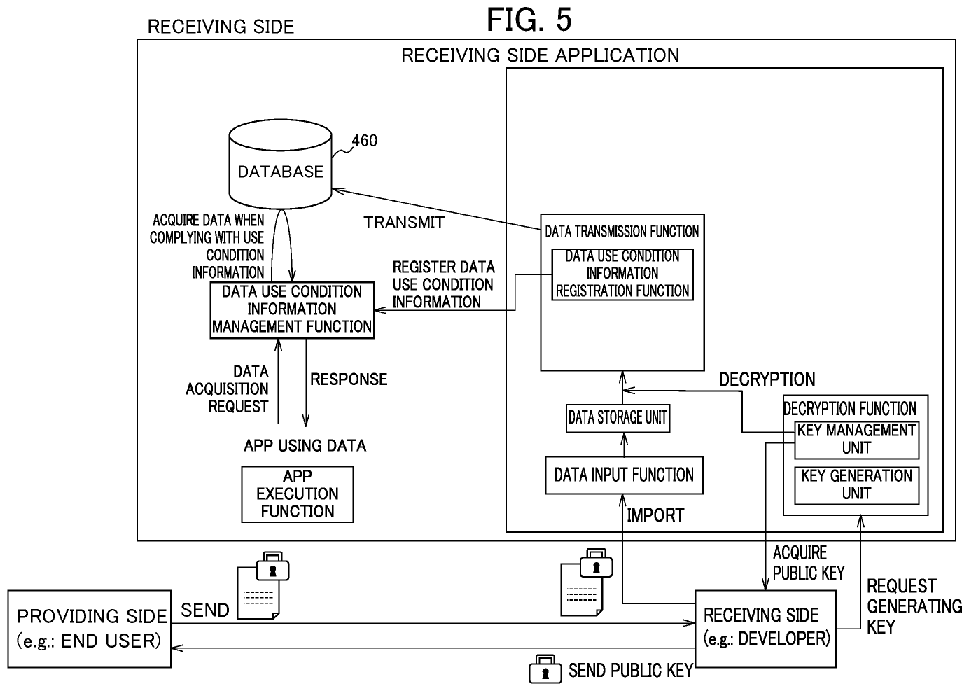

The control unit 410 is, for example, a CPU, and performs overall control of the receiving-side server 400 by executing various programs stored in the storage unit 420. FIG. 5 is a schematic diagram of a receiving-side application program executed by the receiving-side server 400. Hereinafter, the “application” may also be referred to as an “app”.

For example, the control unit 410 executes a program for executing an application for executing an application stored in the storage unit 420 (hereinafter referred to as “application execution processing”).

In addition, the control unit 410 executes a program for performing data use condition information management (hereinafter, referred to as “data use condition information management processing”) that records and manages data use condition information in which information relating to a data file stored in the database 460 and an application or its name permitted to access the data file are associated with each other; checks, when an access request for any data stored in the database 460 is received from an any application being executed, whether or not the application is an application which is permitted to access the data; and permits only the application which is permitted to access the data.

Furthermore, the control unit 410 imports the provision data files provided from the providing-side server 100, temporarily stores them in the storage unit 420, and when the imported provision data files are encrypted, the control unit 410 decrypts them and executes a program for performing data input (hereinafter referred to as “data input processing” or “import processing”) for providing the decrypted provision data files to data transmission processing described later.

Furthermore, the control unit 410 executes a program for performing data transmission (hereinafter referred to as “data transmission processing”) that registers, when available application information in which an application name that is permitted to access the data file is set is added to a data file provided from the outside, data use condition information obtained by associating information relating to the data file with an application or its name that is permitted to access the data file, and then designates the instance ID and transmits the data for storing the data file in the database. As described above, in order to store the data in the instance, the database 460 illustrated in the present embodiment designates the instance ID to transmit the data (specifically, POST transmission) such that the data is stored in the instance identified by the instance ID. That is, in the present embodiment, “data transmission by designating an instance ID and transmitting the data” is synonymous with recording or storing the data in the instance. Furthermore, in order to secure the security of data, when the provision data encrypted using key data of a public key system or a common key based on a common key system is inputted, a program for decrypting a provision data file (hereinafter also referred to as “decryption processing”) may be executed.

It should be noted that the program for data use condition information management processing and the program for data transmission processing may be software included in management software (database operation tool) prepared in advance in the data management system.

Furthermore, the program for the data use condition management processing can be implemented as a program built in API software prepared in advance for the database 460 for accessing data of the database 460.

As described above, by executing a program for application execution processing, a program for import processing, a program for data transmission processing, and a program for data use condition management processing, as shown in FIG. 4, an application execution unit 411, a data import unit 412, a data transmission unit 413, a data use condition information management unit 414, and a decryption processing unit 415 are provided in the control unit 410 as functional configurations.

The application execution unit 411 executes an application stored in an application storage unit (not shown) of the storage unit 420 on the receiving-side server 400 in response to a start-up request from, for example, a user or any operating system.

The data import unit 412 imports the provision data file provided from the providing-side server 100 into the receiving-side server 400. Specifically, the provision data file may be stored in the data storage unit of the storage unit 420.

In order to secure the security of data, when the provision data file is encrypted using the key data of the public key method or the common key of the common key method as described above, it is necessary to decrypt the encrypted provision data file.

Therefore, the control unit 410 may be provided with a decryption processing unit 415. Specifically, for example, when the provision data file is encrypted by applying the public key of the receiving side, the decryption processing unit 415 can decrypt by applying the private key of the receiving side. Furthermore, when the provision data file is encrypted by applying the common key generated on the providing side, the decryption processing unit 415 can decrypt the encrypted common key by applying the public key and the private key on the receiving side, and can decrypt the encrypted provision data by applying the decrypted common key. With such a configuration, the data import unit 412 can output the provision data decrypted by the decryption processing unit 415 to the data transmission unit 413.

Before describing the data transmission unit 413, the data use condition information management unit 414 will be described.

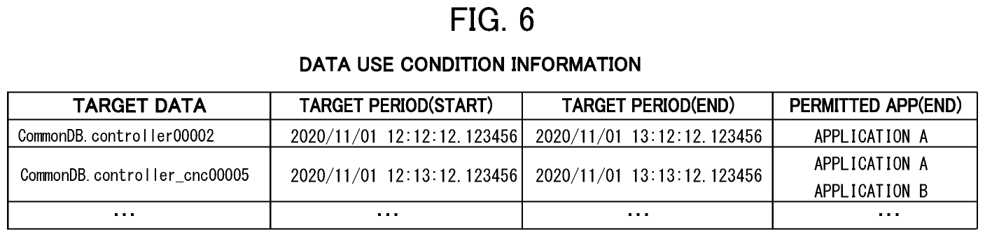

As will be described later, the data transmission unit 413 records and manages information relating to a data file to be transmitted to the database 460 in the data use condition information management unit 414. Here, the information related to the data file includes data use condition information in which, for example, among the instance IDs as data file names and the data transmitted to the instances, a range from the first time stamp to the last time stamp in the time series data as identification information of the first data and identification information of the last data indicating the target range of the data serving as a provision target are associated with an application or its name which is permitted to access the instance. FIG. 6 shows an example of data use condition information. The data use condition information management unit 414 adds access restriction to only the data of the partial range included in the provision data file, and records and manages data use condition information in which the application or its name that is permitted to access the partial range is associated when the access restriction for the remaining range is not added. A null (empty) is associated with the remaining range.

Specifically, in the data use condition information management unit 414, when the newly inputted data use condition information is the same data file name (the same instance ID) as the data use condition information already recorded and managed by the data use condition information management unit 414, the data transmission unit 413 records and manages (updates) the newly inputted data use condition information such that the newly inputted data use condition information is overwritten with the data use condition information already recorded and managed by the data use condition information management unit 414. Thus, for example, when the executable application list information is empty (null) in the newly inputted data usage condition information (i.e., when access restriction is not provided), if the same data file name (the same instance ID) is used, the data file name (the instance ID) included in the data usage condition information already recorded and managed is the same, and the target range of the data serving as a provision target partially overlaps, the data in the overlapping range is updated to enable access from any application.

The data use condition information management unit 414 can update the data use condition information managed by the data use condition information management unit 414 periodically or in response to a request from a user to establish as the latest state. Specifically, the data use condition information management unit 414 may compare the data use condition information with the data recorded in the database 460 periodically or in response to a request from the user, and when data corresponding to the data use condition information is not present in the database 460, the data use condition information management unit 414 may delete the data use condition information (including the permitted application information). When the range of data actually included in the data file corresponding to the data use condition information is smaller than the data target range managed in the data use condition, the data target range managed in the data use condition may be reduced to the range of data included in the data file.

As described above, the data use condition information management unit 414 is a functional unit provided in the control unit 410 by executing a program incorporated in API software prepared in advance for accessing data of the database 460. Accordingly, all applications accessing the data of the database 460 are configured to access via the data use condition information management unit 414.

When the data use condition information management unit 414 receives an access request for data of any data file stored in the database 460 from any application running on the receiving-side server 400, the data use condition information management unit 414 permits only an application permitted to access the data based on the data use condition information to access the data.

More specifically, when the data use condition information management unit 414 receives an access request for any data stored in the database 460 from any application running on the receiving-side server 400, the data use condition information management unit 414 may acquire data requested to be accessed from the database 460 when access to the data is permitted, and output (return) the data to the application and, when access to the data is not permitted, output (return) an error message indicating that access to the data is not permitted to the application.

Finally, the data transmission unit 413 will be described.

When available application information in which an application or its name that is permitted to access the data file is set is added to the data file provided from the data import unit 412, the data transmission unit 413 creates data use condition information in which information relating to the data file is associated with the application or its name that is permitted to access the data file, and registers the data use condition information in the data use condition information management unit 414. As described above, when the access restriction is added only to the data of the partial range included in the provision data file and the access restriction is not added to the remaining range, the data transmission unit 413 may create data use condition information in which the application or its name permitted to access the partial range is associated with and register the data use condition information in the data use condition information management unit 414.

The processing contents of the data transmission unit 413 updating the data use condition information registered in the data use condition information management unit 414 based on the newly created data use condition information have been described in the data use condition information management unit 414, and thus a description thereof is omitted.

The data transmission unit 413 registers data use condition information related to a data file provided from the outside in the data use condition information management unit 414, and then transmits the data file to the database 460. With such a configuration, as described above, since an access request for the data file (instance) stored in the database 460 is requested to the database 460 via the data use condition information management unit 414, an application which is not permitted to access the data file cannot access the data file (i.e., cannot acquire data of the data file). Therefore, it is possible to prevent an application not intended by a data provider from using the data.

The functions of the receiving-side server 400 have been described above.

As described above, in the data management system 1000, for example, when providing the processing data accompanying the operation of the edge device from the providing-side server 100 to the development environment (e.g., the receiving-side server 400) of the developer, the data provider designates in advance an application in which the data can be used, so that, even when the processing data is transmitted (i.e., stored) to a database in the development environment in a decrypted state, other applications that are executed in the same development environment but not designated are not able to access the processing data. With such a configuration, it is possible for the data provider to prevent the virtual device data provided to the development environment from being improperly acquired and used. Furthermore, in each application, it is possible to solve the above-described problems without changing any program code related to the use of the database.

The functional blocks included in the providing-side server 100 and the receiving-side server 400 have been described above.

It should be noted that each server included in the data management system 1000 may be implemented by hardware, software, or a combination thereof. Here, “implemented by software” indicates that it is realized by a computer reading and executing a program (application).

For example, the providing-side server 100 and the receiving-side server 400 can be implemented by incorporating a program (application) for implementing the present embodiment into a general server or a virtual server on the cloud.

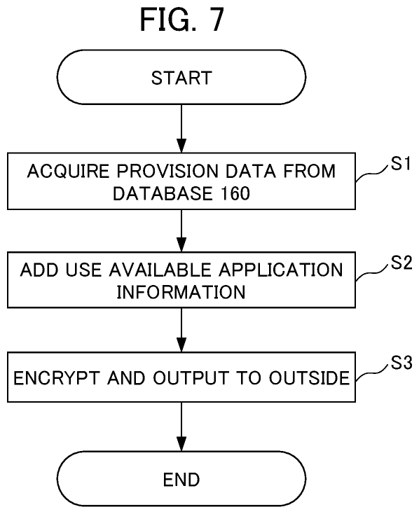

Next, the flow of processing by the providing-side server 100 in the data management system 1000, the flow of processing until the receiving-side server 400 stores the data in the database 460 to enable the application to use the data, and the flow of processing until any application running on the receiving-side server 400 accesses the database 460 to acquire predetermined data will be described with reference to FIGS. 7 to 9.

FIG. 7 is a diagram showing an outline of the flow of processing until the providing-side server 100 provides data acquired from its database to the receiving-side server 400. It should be noted that the provision data is encrypted using key data of the public key system.

In Step S1, in response to an instruction from a data provider, the data acquisition unit 111 acquires data to be provided from the database 160.

In Step S2, the data use condition creation unit 112 creates available application information based on the range of the acquired data and the application name list permitted to be used in the receiving-side server 400, both of which are instructed by the data provider, and adds the available application information to the data acquired in Step S1.

In Step S3, the data output unit 113 encrypts the data file to which the available application information is added in Step S2 with the key data of the public key system (the public key of the receiving side), and outputs the encrypted provision data file to the outside.

Thereafter, the provision data file outputted to the outside is provided to the receiving-side server 400 by a predetermined method.

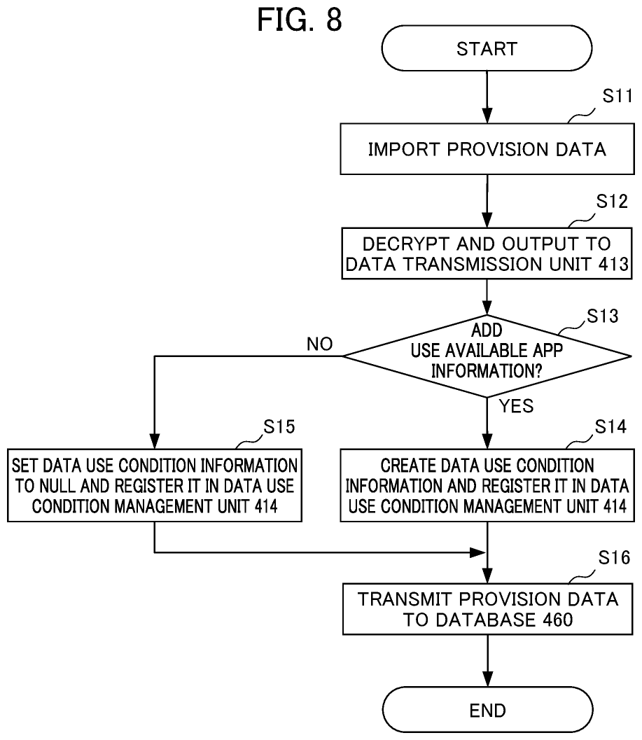

FIG. 8 is a diagram showing an outline of the flow of processing until the receiving-side server 400 receives a provision data file from the providing-side server 100 and stores the file in the database 460 of the receiving-side server 400.

In Step S11, the data import unit 412 stores the provision data file provided from the providing-side server 100 in the data storage unit.

In Step S12, the data import unit 412 decrypts the data file with the key data (private key on the receiving side) of the public key method and outputs the data file to the data transmission unit 413.

In Step S13, the data transmission unit 413 determines whether the available application information is added to the data file outputted from the data import unit 412. When the available application information is added (Yes), the processing proceeds to Step S14. If the available application information is not added (NO), the processing moves to Step S15.

In Step S14, the data transmission unit 413 creates data use condition information based on the available application information, and registers the data use condition information in the data use condition information management unit 414. Thereafter, the processing proceeds to Step S16.

In Step S15, the data transmission unit 413 registers the data use condition information in the data use condition information management unit 414 so as to set the data use condition information to null. Thereafter, the processing proceeds to Step S16.

In Step S16, the data transmission unit 413 transmits the provision data to the database 460. Thus, the data provided in the database 460 is stored, and an application can access the data via the data use condition information management unit 414.

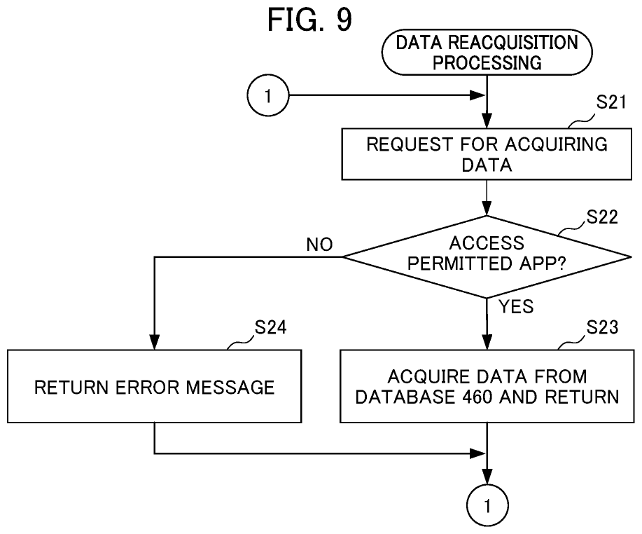

FIG. 9 is a diagram showing an outline of the flow of processing whereby any application running on the receiving-side server 400 accesses the database 460 and acquires predetermined data.

In Step S21, the data use condition information management unit 414 receives an access request for data stored in the database 460 from any application being executed.

In Step S22, the data use condition information management unit 414 determines whether or not the application is permitted to access the data based on the data use condition information managed by the data use condition information management unit 414. In a case where the application is permitted to access the data (Yes), the processing proceeds to Step S23. In a case where the application is not permitted to access the data (NO), the processing moves to Step S24.

In Step S23, the data use condition information management unit 414 acquires the data requested for access from the database 460, and outputs (returns) the data to the requested application. Thereafter, the processing proceeds to Step S21.

In Step S24, the data use condition information management unit 414 outputs (returns) an error message indicating that access to the data is not permitted to the requested application. Thereafter, the processing proceeds to Step S21.

As described above, by applying the data management system 1000 of the present invention, the provider who provides data to the outside designates in advance the application or the name of the application that can use the data in the server of the providing destination, thereby preventing an application that is not intended by the data provider from using the data. With such a configuration, it is possible for the data provider to control the application that can use the data.

On the other hand, even on the receiving side which has received the data, for example, in the receiving-side server 400 as the development environment, only an application that can use the data can use the data and, therefore, the security can be automatically achieved without changing the program code related to the operation of the server and the use of the database in each application.

Although the above-described embodiments are preferred embodiments of the present invention, the scope of the present invention is not limited to the above-described embodiments, and various modifications can be made without departing from the gist of the present invention.

### Modified Example 1

In the above-described embodiment, a configuration in which the provision data file is directly exchanged between both servers, regardless of whether the provision data file is exchanged via the communication unit, or stored in a storage medium and mailed or handed over from the providing-side server 100 to the receiving-side server 400, is exemplified; however, the present invention is not limited thereto. The provision data may be exchanged via a cloud that is set in advance.

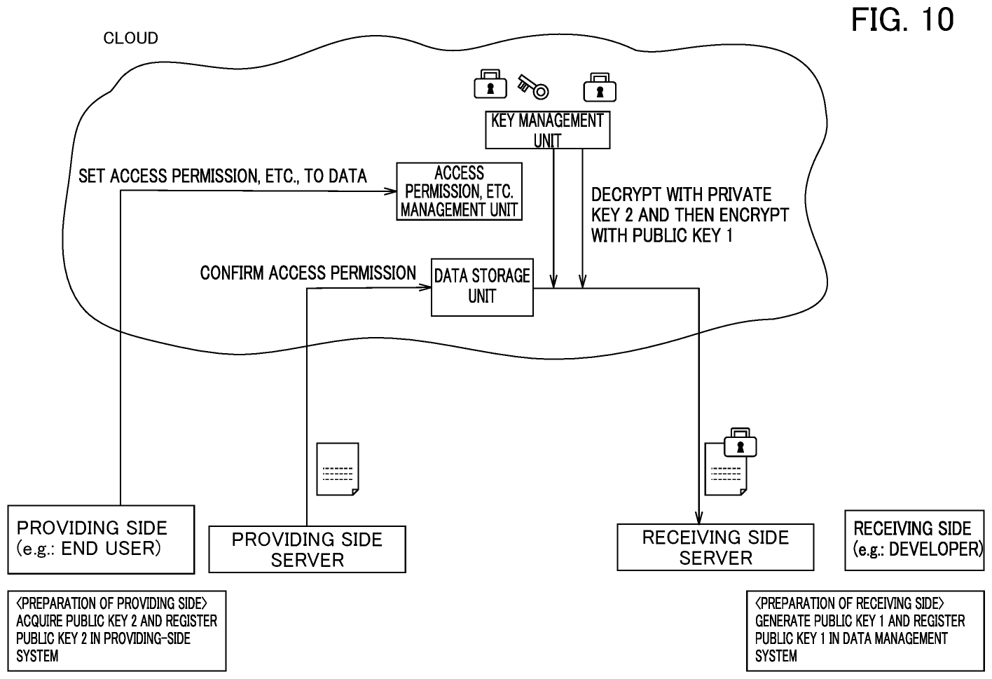

An example of uploading and downloading the provision data via the cloud will be described. FIG. 10 is a schematic diagram showing an example of a mode in which the providing-side server uploads the provision data to the cloud, and the receiving-side server downloads the provision data from the cloud, such that the providing-side server 100 provides the provision data to the receiving-side server 400 via the cloud.

Here, as an example of the encryption method, a public key method is adopted, and an operation of encrypting with a public key or a private key will be described.

First, the cloud is provided with a data management virtual server for managing transmission and reception of data between the providing-side server and the receiving-side server. Here, the provider acquires a public key 2 of the data management virtual server, and registers the public key 2 in the providing-side server 100. Furthermore, it is configured such that that the receiving side generates a public key 1 of the receiving side in advance and registers the public key 1 in the data management virtual server on the cloud.

Thus, the providing-side server 100 (the data output unit 113) encrypts the provision data to be provided to the receiving-side server 400 using the data management virtual server public key 2, and uploads the encrypted data to the data management virtual server. Then, the data management virtual server decrypts the encrypted data using its private key 2 (paired with the public key 2). Then, the data management virtual server encrypts the decrypted provision data using the public key 1 of the receiving side, and downloads the encrypted data to the receiving-side server 400. In this way, the receiving-side server 400 (the data import unit 412) can decrypt it using its private key 1 (paired with the public key 1).

As described above, when the provision data is uploaded from the providing-side server 100 to the data management virtual server, encryption may be performed using the common key generated by the providing-side server 100. In this case, the providing-side server 100 adds the encrypted common key to the data management virtual server using the public key 2, and performs uploading.

Similarly, when the receiving-side server downloads the provision data from the data management virtual server, the data management virtual server may encrypt the provision data using the common key generated by the data management virtual server. In this case, the data management virtual server uses the public key 1 to download the encrypted common key to the receiving-side server.

As described above, the providing-side server 100 can provide the provision data to the receiving-side server 400 via the cloud that is set in advance.

### Modified Example 2

In the above-described embodiment, the providing-side server 100 and the receiving-side server 400 have been described as separate servers; however, one server may function as the providing-side server 100 for providing data created in the server to another server, and may function as the receiving-side server 400 for receiving data created in the other server from the other server. That is, one server may have both the functions of the providing-side server 100 and the receiving-side server 400.

### Modified Example 3

The present invention is not limited to a database system that stores virtual device data and virtual device data. As described above, the present invention can be applied to any data and any database system that stores the data. Specifically, since the terms “instance”, “moment”, “data transmission unit” and “transmit data to database” in the database 160 exemplified in the present embodiment correspond to “data files such as tables”, “one record data”, “data registration unit” and “storing data in database” in a normal database system, respectively, the present invention can be read as described above. Therefore, the present invention can be applied to any data and any database system storing the data.

A program such as an application used in the present invention can be stored and supplied to a computer using various types of non-transitory computer-readable media (non-transitory computer readable medium). Non-transitory computer-readable media includes various types of tangible storage media. Examples of non-transitory computer-readable media include magnetic recording media (for example, flexible disks, magnetic tapes, hard disk drives, etc.), magneto-optical recording media (e.g., magneto-optical disks), CD-ROMs (Read Only Memory), CD-Rs, CD-R/Ws, semiconductor memory (for example, mask ROM, PROM (Programmable ROM), EPROM (Erasable PROM), flash ROM, and RAM (random access memory) are used). The program may also be provided to a computer by various types of transitory computer readable media (transitory computer readable medium). Examples of transitory computer-readable media include electrical signals, optical signals, and electromagnetic waves. The transitory computer-readable medium can provide the program to the computer via wired or wireless communication paths such as electric wires and optical fibers.

In view of the above, the present invention can take various embodiments having the following configurations.

(1) The receiving-side server 400 serving as the server of the present disclosure is a server including: the control unit 410 and the database 460, and the control unit 410 includes the data use condition information management unit 414 configured to record and manage data use condition information in which information relating to a data file stored in the database 460 and an application or a name of the application permitted to access the data file are associated with each other, and when receiving an access request for any data stored in the database 460 from any application running, permits only an application permitted to access the data based on the data use condition information to access the data; and the data transmission unit 413 configured to, when available application information in which an application or a name of the application that is permitted to access the data file is set is added to the data file provided from outside of the receiving-side server 400, register data use condition information in which information relating to the data file is associated with the application or the name of the application that is permitted to access the data file in the data use condition information management unit 414, and transmit the data file to the database 460.

Thus, when the data provider provides data to the outside, the data provider designates in advance the application or the name of the application that can use the data, so that another application that is not designated cannot access the data. It is possible to prevent an application that is not intended by a data provider from using the data.

(2) In the receiving-side server 400 serving as the server according to (1), the data use condition information may include at least data information including identification information of a data file and range information of data stored in the data file, and application identification information that is permitted to access data included in the range information of the data.

With such a configuration, the data provider can designate permission and denial of access in the provision data according to the range of the data. The data provider can finely control data use permission as necessary.

(3) In the receiving-side server 400 serving as the server according to (2), the data stored in the data file may correspond to at least one of data indicating an action state of an edge device, data indicating a production state of the edge device, data indicating a quality state of a product of the edge device, data indicating an operation state of the edge device, and data indicating an event of the edge device, and the range information of the data may include a period relating to a time stamp generated from the data.

With such a configuration, it is possible to eliminate a hazardous risk (for example, forecasting of the manufacturing capabilities of each machine, the manufacturing capabilities of factories, the sales of companies operating factories, and the like), for example, by analyzing the machine information when the processing data accompanying the operation of the edge device in the manufacturing site is used for an unintended application.

(4) In the receiving-side server 400 serving as the server according to any one of (1) to (3), the data use condition information management unit 414 may receive an access request for any data stored in the database 460 from the application, and when access to the data is permitted, the data use condition information management unit may acquire data requested for access from the database 460 and output the data to the application, and when access to the data is not permitted, may output error data to the application.

With such a configuration, it is possible to obtain the same advantageous effect as in (1) to (3), and it is also possible to easily grasp the cause of the error and improve the development efficiency by immediately returning the error data to the developer when a data acquisition request is erroneously made.

(5) The receiving-side server 400 serving as the server according to any one of (1) to (3) may further include the communication unit 430, and a data file provided from outside of the receiving-side server 400 and imported to the receiving-side server 400 may be received via the communication unit 430.

With such a configuration, for example, it is possible to avoid complicated operation due to manual operation.

(6) The data management method according to the present disclosure is directed to a data management method for storing a data file provided from outside in an internal database 460 and allowing an internal application to use the data file according to the present disclosure, and the method executed by a computer including the control unit 410 and the database 460, includes the steps of: recording and managing data use condition information in which information relating to a data file stored in the database 460 and an application or a name of the application permitted to access the data file are associated with each other, and when receiving an access request for any data stored in the database 460 from any application running, permitting only an application permitted to access the data based on the data use condition information to access the data; and when available application information in which an application or a name of the application that is permitted to access the data file is set is added to the data file provided from outside of the data management server, registering data use condition information in which information relating to the data file is associated with the application or the name of the application that is permitted to access the data file, and transmitting the data file to the database 460.

With such a configuration, it is possible for the data management method to achieve the same advantageous effect as in (1).

(7) The data management program according to the present disclosure is directed to a data management program for storing a data file provided from outside in an internal database 460 and allowing an internal application to use the data file, and the program executed by a computer including the control unit 410 and the database 460 includes the steps of: recording and managing data use condition information in which information relating to a data file stored in the database 460 and an application or a name of the application permitted to access the data file are associated with each other, and when receiving an access request for any data stored in the database 460 from any application running, permitting only an application permitted to access the data based on the data use condition information to access the data; and when available application information in which an application or a name of the application that is permitted to access the data file is set is added to the data file provided from outside of the data management server, registering data use condition information in which information relating to the data file is associated with the application or the name of the application that is permitted to access the data file, and transmitting the data file to the database 460.

With such a configuration, it is possible for the data management program to achieve the same advantageous effect as (1).

(8) The computer-readable recording medium according to the present disclosure is directed to a computer-readable recording medium storing the data management program according to (7).

With such a configuration, it is possible for the computer-readable recording medium to achieve the same advantageous effect as in (1).

(9) The data management system 1000 according to the present disclosure is directed to a data management system 1000 including: the receiving-side server 400 serving as the server according to (1); and the providing-side server 100 serving as a server that creates a data file provided from outside to the receiving-side server 400. The providing-side server 100 includes the control unit 110, and the database 160. The control unit 110 includes the data acquisition unit 111 configured to acquire a data file stored in the database 160, the data use condition creation unit 112 configured to add to the data file available application information in which an application or a name of the application executed by the receiving-side server 400 that is permitted to access the data file is set, and the data output unit 113 configured to output the data file to which the available application information is added by the data use condition creation unit 112 to outside as a provision data file to be provided to the receiving-side server 400.

With such a configuration, it is possible for the data management system to achieve the same advantageous effect as (1).

### EXPLANATION OF REFERENCE NUMERALS

1000 data management system
100 providing-side server
110 control unit
111 data acquisition unit
112 data use condition creation unit
113 data output unit
120 storage unit
130 communication unit
160 database
400 receiving-side server
410 control unit
411 application execution unit
412 data import unit
413 data transmission unit
414 data use condition information management unit
420 storage unit
430 communication unit
460 database

1. A data management server comprising:
a control unit;
a database;
a data use condition information management unit configured to record and manage data use condition information in which information relating to a data file stored in the database and an application or a name of the application permitted to access the data file are associated with each other, and when receiving an access request for any data stored in the database from any application running, permits only an application permitted to access the data based on the data use condition information to access the data; and
a data transmission unit configured to, when available application information in which an application or a name of the application that is permitted to access the data file is set is added to the data file provided from outside of the data management server, register data use condition information in which information relating to the data file is associated with the application or the name of the application that is permitted to access the data file in the data use condition information management unit, and transmit the data file to the database.

2. The data management server according to claim 1, wherein the data use condition information includes at least data information including identification information of a data file and range information of data stored in the data file, and application identification information that is permitted to access data included in the range information of the data.

3. The data management server according to claim 2, wherein the data stored in the data file corresponds to at least one of data indicating an action state of an edge device, data indicating a production state of the edge device, data indicating a quality state of a product of the edge device, data indicating an operation state of the edge device, and data indicating an event of the edge device, and the range information of the data includes a period relating to a time stamp generated from the data.

4. The data management server according to claim 1, wherein the data use condition information management unit receives an access request for any data stored in the database from the application and, when access to the data is permitted, the data use condition information management unit acquires data requested for access from the database and outputs the data to the application and, when access to the data is not permitted, outputs error data to the application.

5. The data management server according to claim 1, further comprising a communication unit,
wherein a data file provided from outside of the data management server and imported to the data management server is received via the communication unit.

6. A data management method for storing a data file provided from outside in an internal database and allowing an internal application to use the data file,
the method executed by a computer including a control unit and a database, the method comprising the steps of:
recording and managing data use condition information in which information relating to a data file stored in the database and an application or a name of the application permitted to access the data file are associated with each other and, when receiving an access request for any data stored in the database from any application running, permitting only an application permitted to access the data based on the data use condition information to access the data; and
when available application information in which an application or a name of the application that is permitted to access the data file is set is added to the data file provided from outside of the data management server, registering data use condition information in which information relating to the data file is associated with the application or the name of the application that is permitted to access the data file, and transmitting the data file to the database.

7. A non-transitory computer readable medium encoded with a data management program for storing a data file provided from outside in an internal database and allowing an internal application to use the data file,
the program executed by a computer including a control unit and a database, comprising the steps of:
recording and managing data use condition information in which information relating to a data file stored in the database and an application or a name of the application permitted to access the data file are associated with each other, and when receiving an access request for any data stored in the database from any application running, permitting only an application permitted to access the data based on the data use condition information to access the data; and
when available application information in which an application or a name of the application that is permitted to access the data file is set is added to the data file provided from outside of the data management server, registering data use condition information in which information relating to the data file is associated with the application or the name of the application that is permitted to access the data file, and transmitting the data file to the database.

8. (canceled)

9. A data management system comprising:
a receiving-side server serving as a data management server according to claim 1; and
a providing-side server that creates a data file provided from outside to the receiving-side server,
the providing-side server including
a control unit, and
a database,
the control unit including
a data acquisition unit configured to acquire a data file stored in the database,
a data use condition creation unit configured to add, to the data file, available application information in which an application or a name of the application executed by the receiving-side server that is permitted to access the data file is set, and
a data output unit configured to output the data file to which the available application information is added by the data use condition creating unit to outside as a provision data file to be provided to the receiving-side server.
